(19) United States
(12) Patent Application Publication
(10) Pub. No.: US 2017/0032484 A1
(43) Pub. Date: Feb. 2, 2017

(54) SYSTEMS, DEVICES, AND METHODS FOR DETECTING FIREARM STRAW PURCHASES

(71) Applicant: Wal-Mart Stores, Inc., Bentonville, AR (US)

(72) Inventors: Jacob A. Nunley, Pea Ridge, AR (US); Kyle Woodruff, Bentonville, AR (US); Chad Austin Brown, Rogers, AR (US); Kelly L. Kapoor, Rogers, AR (US); Ben Garnett, Centerton, AR (US)

(21) Appl. No.: 15/221,182

(22) Filed: Jul. 27, 2016

Related U.S. Application Data
(60) Provisional application No. 62/199,626, filed on Jul. 31, 2015.

(51) Int. Cl. G06Q 50/26; G06F 17/30; G06Q 20/10

(52) U.S. Cl. CPC G06Q 50/265; G06Q 20/10; G06F 17/30949; G06F 17/30867

(57) ABSTRACT

Provided herein are methodologies, systems, apparatus, and non-transitory computer-readable media for detecting firearm straw purchases and providing approval or denial of an attempted firearm purchase. Address information is collected from anyone attempting to purchase a firearm. This address information is normalized to create a normalized address string, which accounts for misspellings and/or abbreviations in the address information. This normalized address string is compared against normalized addresses associated with people who are prohibited from purchasing a firearm, and a similarity coefficient is calculated. The similarity coefficient is then compared against a threshold value, and if the similarity coefficient is greater than the threshold value, the firearm purchase can be declined. If, however, the similarity coefficient is below the threshold value, the firearm purchase can be approved.

### RELATED APPLICATIONS

This application claims priority to U.S. Provisional Patent Application Ser. No. 62/199,626 entitled “SYSTEMS, DEVICES, AND METHODS FOR DETECTING FIREARM STRAW PURCHASES,” filed on Jul. 31, 2015, the content of which is hereby incorporated by reference in its entirety.

### BACKGROUND

In general, persons attempting to purchase a firearm must provide identification information, including address information. Certain existing firearm regulation techniques allow store associates to manually cross-reference customer information against lists of prohibited addresses associated with persons prohibited from purchasing firearms.

### BRIEF SUMMARY

Exemplary embodiments of the present disclosure provide systems, methods, and devices for detecting firearm straw purchases and providing approval or denial of attempted firearm purchases.

In accordance with exemplary embodiments, a method of providing approval or denial of an attempted firearm purchase is disclosed. The method includes receiving, in an electronic computer-readable format at a normalized address generator, address information, including address elements, of a person attempting to purchase a firearm. The method also includes using the normalized address generator to transform at least one of the address elements to a normalized address element and generate a normalized address string including the normalized address element. Additionally, the method also includes using a normalized string comparison engine to generate a similarity coefficient by comparing the normalized address string to a prohibited normalized address string corresponding to a prohibited address associated with a person prohibited from purchasing firearms. The method further includes comparing the similarity coefficient to a first threshold value and providing approval or denial of the attempted firearm purchase based at least in part on a comparison of the similarity coefficient to the first threshold value.

In accordance with exemplary embodiments, a system for providing approval or denial of an attempted firearm purchase is disclosed. The system includes one or more servers programmed to receive, in an electronic computer-readable format at a normalized address generator, address information of a person attempting to purchase a firearm, the address information including address elements. The one or more servers are also programmed to use the normalized address generator to transform at least one of the address elements to a normalized address element and to generate a normalized address string including the normalized address element. The one or more servers are further programmed to generate a similarity coefficient, using a normalized string comparison engine, by comparing the normalized address string to a prohibited normalized address string corresponding to a prohibited address associated with a person prohibited from purchasing firearms. Additionally, the one or more servers are programmed to compare the similarity coefficient to a first threshold value. The system also includes an electronic display device programed to provide approval or denial of the attempted firearm purchase based at least in part on a comparison of the similarity coefficient to the first threshold value.

In accordance with exemplary embodiments, a non-transitory computer readable medium storing instructions executable by a processing device is disclosed, wherein execution of the instructions causes the processing device to implement a method of providing approval or denial of an attempted firearm purchase. The method includes receiving, in an electronic computer-readable format, address information of a person attempting to purchase a firearm, the address information including address elements. The method also includes transforming at least one of the address elements to a normalized address element and generating a normalized address string including the normalized address element. The method further includes generating a similarity coefficient by comparing the normalized address string to a prohibited normalized address string corresponding to a prohibited address associated with a person prohibited from purchasing firearms. Additionally, the method also includes comparing the similarity coefficient to a first threshold value and providing approval or denial of the attempted firearm purchase based at least in part on a comparison of the similarity coefficient to the first threshold value.

Any combination or permutation of the embodiments is envisioned. It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

The foregoing and other features and advantages provided by the present disclosure will be more fully understood from the following description of exemplary embodiments when read together with the accompanying drawings, in which:

FIG. 1 is a flowchart illustrating an exemplary method of detecting a firearm straw purchase, according to embodiments of the present invention.

FIG. 2 is a flowchart illustrating another exemplary method of detecting a firearm straw purchase, according to embodiments of the present invention.

FIG. 3 is a flowchart illustrating another exemplary method of detecting a firearm straw purchase, according to embodiments of the present invention.

FIG. 4 illustrates the computation of variables for calculating a dice coefficient, according to exemplary embodiments of the present invention.

FIG. 5 is a diagram of an exemplary network environment suitable for a distributed implementation of exemplary embodiments of the present invention.

FIG. 6 is a block diagram of an exemplary computing device that can be used to perform exemplary processes in accordance with exemplary embodiments of the present invention.

### DETAILED DESCRIPTION

Following below are more detailed descriptions of various concepts related to, and embodiments of, inventive methods, apparatus, and systems for detecting firearm straw purchases. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

As used herein, the term “includes” means includes but is not limited thereto, while the term “including” means including but is not limited thereto. The term “based on” means based at least in part on.

Example methodologies, systems, apparatus, and non-transitory computer-readable media are described herein to facilitate detecting firearm straw purchases. Straw purchases occur when a person purchases a firearm for another person who either cannot, or will not, purchase the firearm for themselves. As noted above, conventionally clerks check buyer information against information stored in a database that indicates prohibited buyers. Unfortunately if the buyer information is misspelled, either intentionally or by mistake, the check by the clerk will not detect a prohibited buyer. This is an increased problem in the event of straw purchasers repeatedly using slightly altered information to make illicit purchases. Embodiments of the present invention such as those described herein help to prevent such illegal transactions.

Under federal law, anyone attempting to purchase a firearm must provide an address. For example, the address may be provided by using a federal 4473 form. According to exemplary embodiments, the address information collected on the 4473 form can be normalized using several operations. For example, special characters or any character other than a letter or number can be replaced with a space. Substrings or elements can be identified within the address string based on the spacing of the address string. Subsequently, at least one of the substrings or elements of the address string is compared against a hash-table that has been created based on common abbreviations for address elements. Based on this comparison, the system can identify the normalized form of each element in an address string based on the hash-table. For example, a customer attempting to purchase a firearm may enter the term “apartment” in a number of different ways. The term may be completely spelled out, or it may be commonly abbreviated as “apt” or “aptmt,” etc. In this example, any of the commonly abbreviated forms, as well as the entirely spelled-out word, can be normalized to “APT.” Any substrings or elements of the address string that do not match a standard address element or special character can be entered as-is into the normalized address string. Such elements may include street names or numbers, such as “581 broadway.” Thus, the address string entered by the customer is transformed from a simple text string into a normalized address string that includes normalized address elements and can be used in the detection of firearm straw purchases, as disclosed herein.

According to exemplary embodiments, once the address information has been converted or transformed into a normalized address string, the normalized address string can be compared against addresses for which firearm purchases are prohibited. For example, the normalized address string can be compared against a database or record of normalized prohibited addresses which have been associated with firearm straw purchases in the past, or are otherwise associated with individuals who are prohibited from purchasing firearms. This database may include information on prohibited addresses from a number of different store locations. Thus, if a person attempts to make a firearm straw purchase at one location and is denied, the system will detect if the person goes to another store location and attempts to make another firearm straw purchase using an address that is the same as, or substantially similar to, a prohibited address.

The normalized address string comparison can be done, for example, by calculating a similarity coefficient for the normalized address string. A similarity coefficient is a statistical tool used to compare the similarity and diversity of different sample sets. In one embodiment, the similarity coefficient may be a dice coefficient (a dice coefficient is a type of similarity coefficient in which greater weight is given to agreements between data in the sample sets). In such an example, the normalized address string can be broken down into two-character pairs, which are then compared against the two-character pairs from prohibited addresses stored in the database or record of past addresses associated with firearm straw purchases, or otherwise associated with individuals who are prohibited from purchasing firearms. According to exemplary embodiments, the dice coefficient can be computed based on the frequency in overlap between two-character pairs from the normalized address string and two-character pairs from a prohibited address. The value of the dice coefficient can be used to determine the degree of match between the normalized address string and a prohibited address. In one example, if the dice coefficient is 100, then there is a 100% match between the normalized address string and a prohibited address.

According to exemplary embodiments, once the dice coefficient has been calculated, it can be compared against one or more approval threshold values in order to determine a course of action for a sales associate. For example, in one embodiment any dice coefficient less than 20 may result in an approval of the firearm purchase because there is no significant match between the normalized address string and any prohibited address stored in the database. In contrast, any dice coefficient greater than 70 may result in a rejection of the firearm purchase because the normalized address string is substantially similar to a prohibited address. In another example, a dice coefficient between 20-70 may generate an alert for the sales associate of a possible straw firearm purchase and that further identification information is needed so that the address may be confirmed, etc. It will be appreciated that other threshold values triggering similar or different actions than those explicitly described herein are also within the scope of the present invention. Once the dice coefficient has been compared against one or more threshold values, the result of the transaction may be recorded; e.g. whether the transaction was rejected, approved, or whether any additional information was obtained from the customer. The result of the transaction, as well as any additional information obtained from the customer, can then be stored in a database for future reference.

Exemplary embodiments are described below with reference to the drawings. One of ordinary skill in the art will recognize that exemplary embodiments are not limited to the illustrative embodiments, and that components of exemplary systems, devices and methods are not limited to the illustrative embodiments described below.

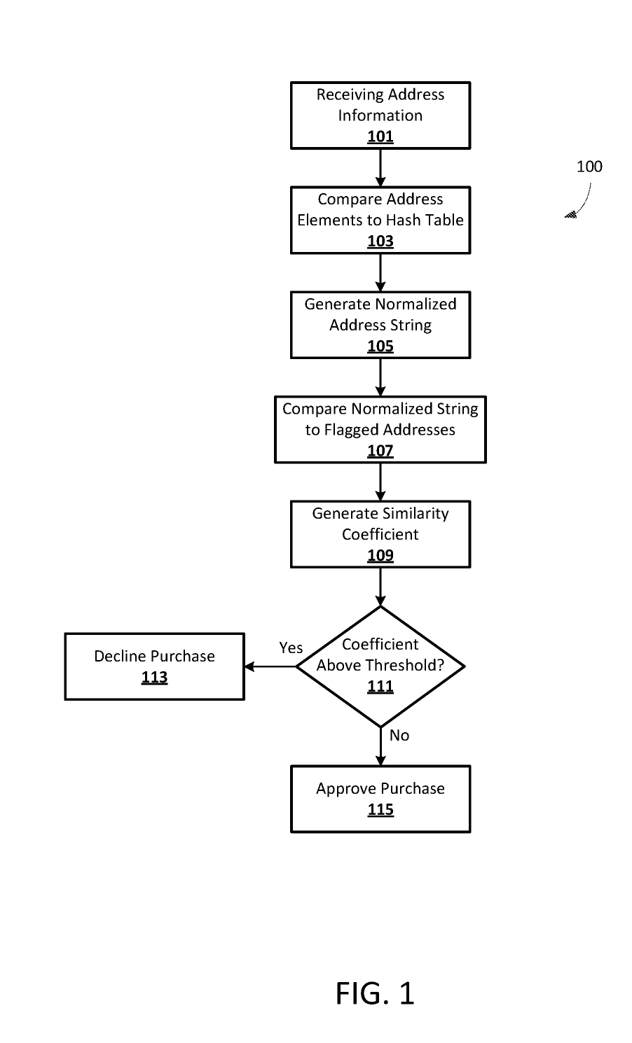

FIG. 1 is a flowchart illustrating an example method 100 for detecting firearm straw purchases. In step 101, a server receives address data, in an electronic computer-readable format, corresponding to the address of a person attempting to purchase a firearm. The address data can be collected, for example, via federal form 4473, which is a form that must be filled out by anyone attempting to purchase a firearm.

In step 103, the address entered by the person attempting to purchase a firearm is compared against a hash table, which includes commonly used address inputs and/or address abbreviations. For example, as described above, the term “apartment” may be commonly abbreviated in a number of ways, and the hash table can include a listing of commonly used spellings and/or abbreviations for the term “apartment.” The hash table can also include a list of normalized address elements corresponding to commonly used address elements. In some examples, the hash table can include a list of standardized U.S. Postal Service abbreviations, which can be used to normalize address terms or elements. In exemplary embodiments, once the address terms are compared against the hash table, each term associated with an element in the hash table can be transformed into a normalized address element. In exemplary embodiments, the address element “street” can be normalized or transformed to “ST” and address element “apartment” or “aptmt” can be normalized to “APT.”

In step 105, a normalized address string is generated, which includes the normalized address elements identified in step 103 and other non-normalized elements from the received address information. Once the normalized address string has been generated, it can be compared in step 107 against electronically stored and normalized address strings that correspond to prohibited addresses. These prohibited addresses are ones associated with persons who are legally or otherwise prohibited from purchasing firearms and are retrieved for comparison with the normalized address strings.

In step 109, a similarity coefficient is generated based on the comparison of the normalized address string and a prohibited normalized address string of the prospective buyer. In exemplary embodiments, the similarity coefficient is a dice coefficient, computed using equation (1) below, based on the similarity between pairs of characters from the normalized address string and a prohibited normalized address string.

$$Dice coefficient = 100 * \frac{2 C}{A + B} \qquad ( 1 )$$

In equation (1), variables A and B correspond to the number of two-character pairs from the prohibited normalized address string and the normalized address string, respectively.

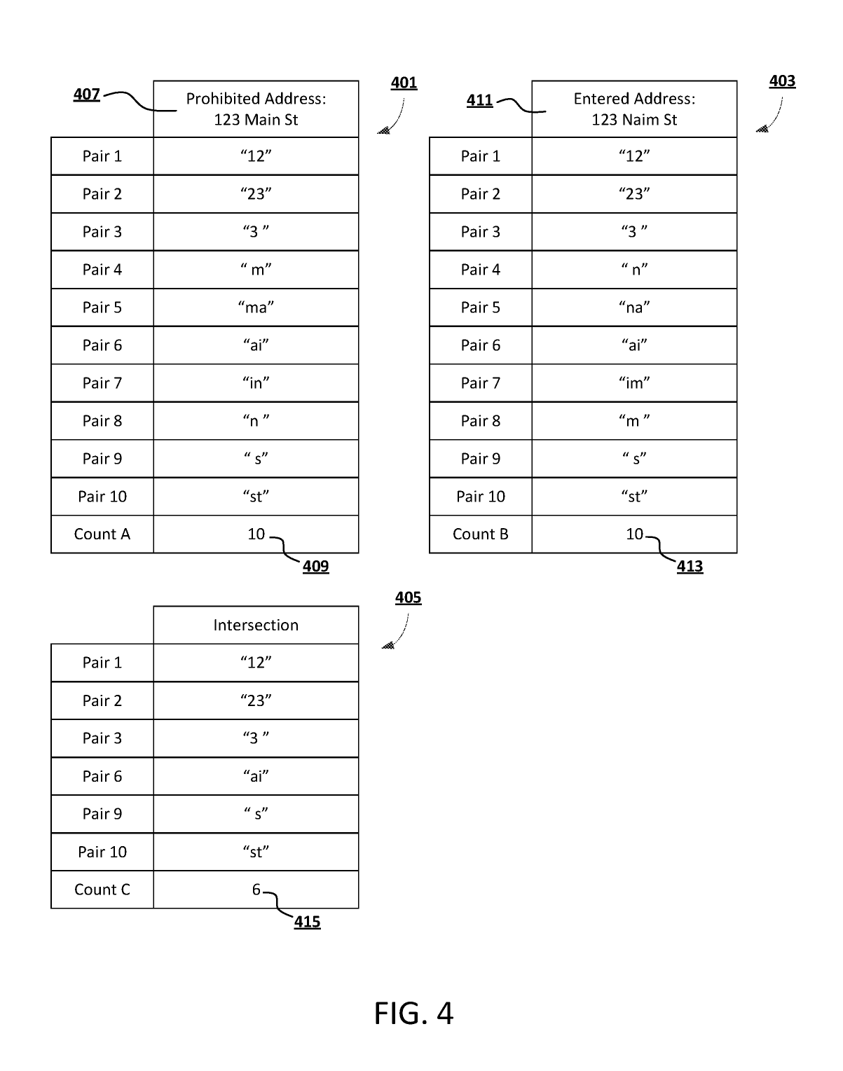

Variable C corresponds to the number of overlapping two-character pairs between the prohibited normalized address string and the normalized address string. The generation of a dice coefficient by embodiments of the present invention is discussed in greater detail below in reference to FIG. 4.

In step 111, once the similarity coefficient has been generated, it is compared to a threshold value in order to determine whether to approve or decline the attempted firearm purchase. In exemplary embodiments, a similarity coefficient that is above the threshold value signals a significant match to a prohibited address, and therefore the purchase attempt is declined at step 113. If, however, the similarity coefficient is below the threshold value, that means there is no significant match between the normalized address and any prohibited address, and the purchase attempt is approved at step 115.

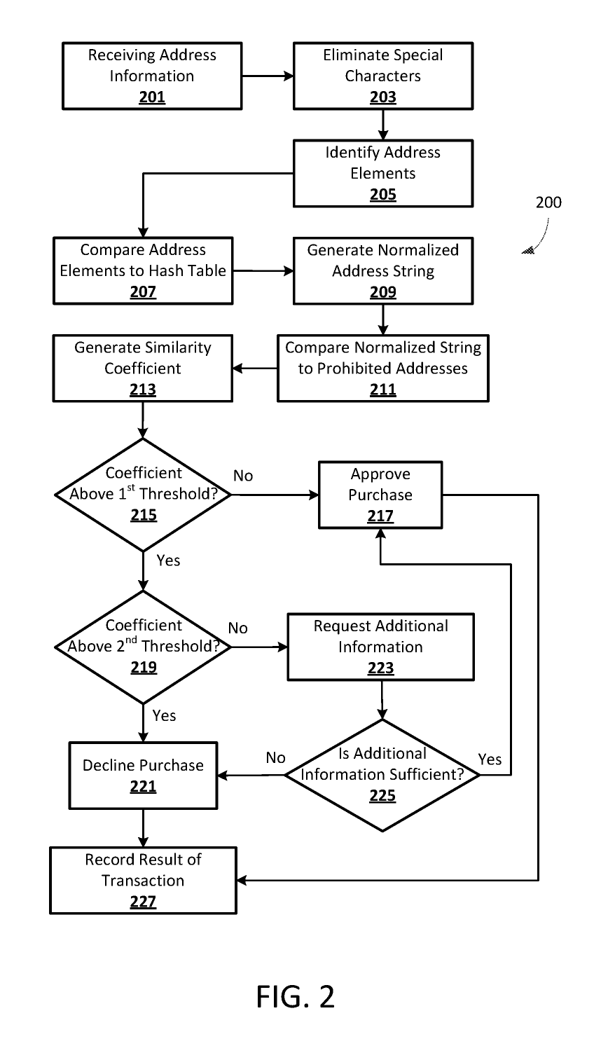

FIG. 2 is a flowchart illustrating an exemplary method 200 for detecting firearm straw purchases, according to an embodiment. In step 201, a server receives address data, in an electronic computer-readable format, corresponding to the address of a person attempting to purchase a firearm. The address data can be collected, for example, via federal form 4473, which is a form that must be filled out by anyone attempting to purchase a firearm.

In step 203, special characters within an address string, such as punctuation marks, hyphens, symbols, etc. are eliminated. Once special characters have been eliminated from the address string, address elements are identified in step 205. Address elements may include number strings, street names, region names, region abbreviations, or common address terms, such as “street” or “apartment.” In some cases, the address elements can be abbreviated or misspelled, as discussed above. The identified address elements are compared against a hash table in step 207. In exemplary embodiments, the hash table can include a listing of commonly used spellings and/or abbreviations for address elements. In some examples, the hash table can include a list of standardized U.S. Postal Service abbreviations, which can be used to normalize address elements.

In step 209, once the address elements are compared against the hash table and the special characters are eliminated, the address string can be transformed into a normalized address string. For example, in exemplary embodiments, the address element “street” can be normalized or transformed to “ST” and address element “apartment” or “aptmt” can be normalized to “APT.” For example, the address string “123 Broadway, Aptmt 34, Boston Mass.” can be normalized to “123 Broadway APT 34 Boston Mass.”

In step 211, the normalized address string is compared against normalized address strings that correspond to prohibited addresses. These prohibited addresses are ones associated with persons who are legally or otherwise prohibited from purchasing firearms. As discussed above, in reference to FIG. 1, step 109, a similarity coefficient is calculated in step 213. The similarity coefficient may be, in exemplary embodiments, a dice coefficient computed using equation (1) above, based on the similarity between pairs of characters from the normalized address string and a prohibited normalized address string. The generation of a dice coefficient is discussed in greater detail below in reference to FIG. 4.

In step 215, the similarity coefficient generated in step 213 is compared against a first threshold value. If the similarity coefficient is not greater than the first threshold value, this can signify that there is no substantial match between the normalized address string and a prohibited address string, and the firearm purchase may be approved in step 217. If, however, the similarity coefficient is above the first threshold value, this can signify that there is a partial match between the normalized address string and a prohibited address. If this is the case, the similarity coefficient is compared against a second, greater threshold value, in step 219. If the similarity coefficient is greater than the second threshold value, the firearm purchase can be declined in step 221. In exemplary embodiments, if the similarity coefficient is greater than the second threshold value, the firearm purchase can be automatically declined by a point of sale system. If the similarity coefficient is greater than the first threshold value but lower than the second threshold value, a sales associate may be prompted to request additional information in step 223 from the person attempting to purchase the firearm. In exemplary embodiments, the additional information includes the customer's resident history or identification information.

In step 225, it is determined whether the additional information received in step 223 is sufficient to approve the attempted firearm purchase. For example, if the customer attempting to purchase a firearm has an address that is similar to a someone who is prohibited from purchasing a firearm, and a review of the customer's ID confirms that they do not live at the exact location associated with someone prohibited from purchasing a firearm and are not otherwise associated with that individual, the purchase can be approved in step 217. If, however, the additional information received in step 223 confirms that the customer attempting to purchase a firearm is associated with the prohibited address, the purchase can be declined in step 221.

In step 227, the final result of the transaction is recorded in a database. In exemplary embodiments, the database may include the results of any approved or declined firearm purchase attempts, along with their associated addresses, in order to update the list of prohibited addresses.

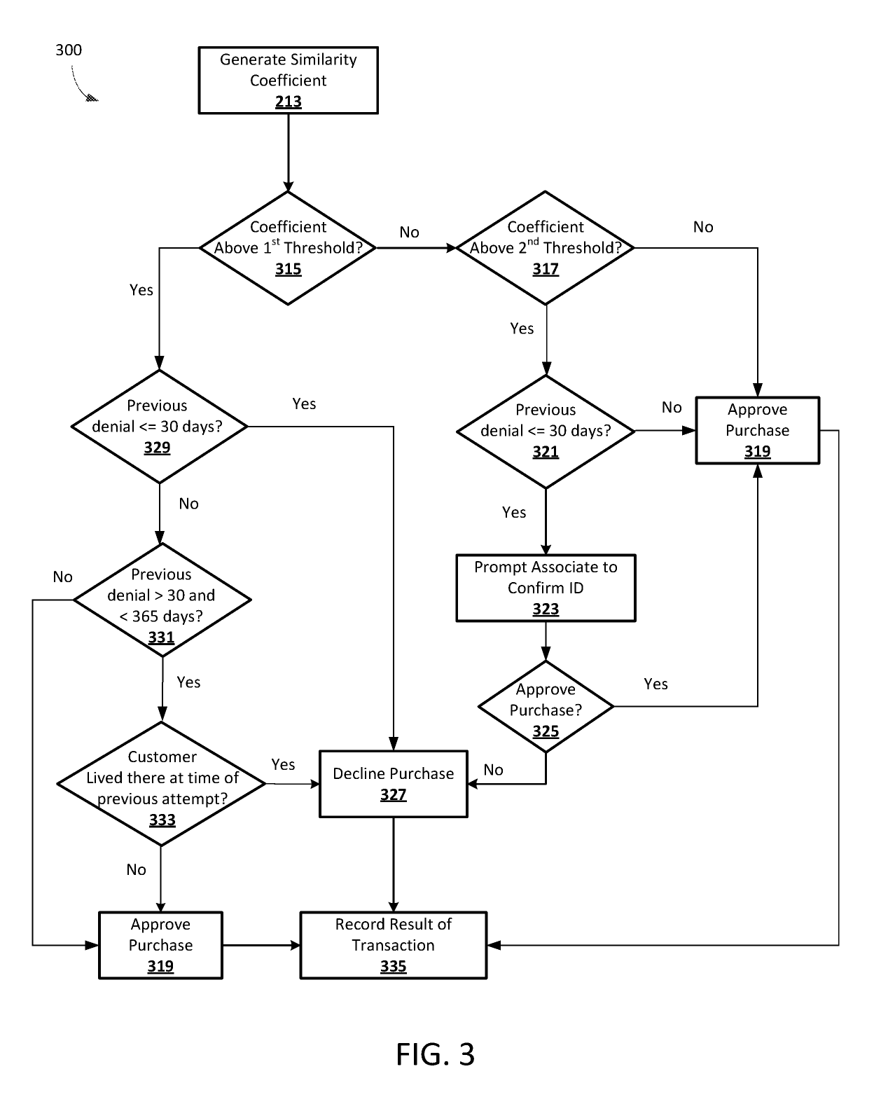

FIG. 3 is a flowchart illustrating another example method 300 for detecting firearm straw purchases, according to exemplary embodiments of the present disclosure. According to exemplary method 300, a similarity coefficient is generated as described above in reference to step 213 of FIG. 2.

In step 315, the similarity coefficient generated in step 213 is compared against a first threshold value. If it is determined in step 315 that the similarity coefficient is not greater than the first threshold value, it is then compared against a second lower threshold value in step 317. If the similarity coefficient is not greater than the second threshold value, this can signify that there is no substantial match between the normalized address string and a prohibited address string, and the firearm purchase may be approved in step 319. If it is determined in step 317 that the similarity coefficient is greater than or equal to the first higher threshold value, but it is determined in step 321 that the most recent firearm purchase denial corresponding to the prohibited address was made more than 30 days ago, the purchase can be approved in step 319. However, if it is determined in step 321 that the most recent firearm purchase denial was made less than 30 days ago, a sales associated is prompted in step 323 to confirm the customer's ID. Confirming the customer's ID may include entering the customer's identification information into a government database in order to determine whether the customer is prohibited from purchasing a firearm. If it is determined in step 325 that the customer is approved for the purchase of a firearm after confirming the customer's ID, the purchase can be approved in step 319. If, after checking the customer's ID it is determined in step 325 that the customer is not approved for the purchase of a firearm, the purchase can be declined in step 327.

In another exemplary embodiment, if it is determined in step 315 that the similarity coefficient is greater than the first threshold value, the system may determine in step 329 whether the previous firearm purchase denial was within the past 30 days. If it is determined in step 329 that the last firearm purchase denial was within the past 30 days, the purchase attempt can be declined in step 327. In this case, the system may prompt a message to the sales associate that the sale has been blocked due to a substantial match between the entered address and a prohibited address, where an illicit firearm purchase attempt was made within the past month. If, however, the previous purchase denial was more than 30 days before the current purchase attempt, the system may determine in step 331 whether the previous purchase denial was between 30 and 365 days before the current purchase attempt. If the previous purchase denial corresponding to the prohibited address was more than 365 days ago, the purchase may be approved in step 319. If, however, the previous purchase denial was greater than 30 days ago and less than 365 days ago, the sales associate may be prompted to request additional information from the customer. The system may then determine in step 333 whether the customer lived there at the time of the previous firearm purchase denial. If it is determined in step 333 that the customer lived at the prohibited address at the time of the previous firearm purchase denial, the purchase can be declined in step 327. In contrast, if it is determined in step 333 that the customer did not live at the prohibited address at the time of the previous firearm purchase denial, the purchase can be approved in step 319.

In step 335, the final result of whether the transaction has been approved in step 319 or declined in step 327 is recorded in a database. In exemplary embodiments, the database may include the results of any approved or declined firearm purchase attempts, along with addresses and identification information relating to persons attempting to purchase firearms, in order to update the list of prohibited addresses.

FIG. 4 illustrates the computation of variables for calculating a dice coefficient, according to exemplary embodiments of the present disclosure. In this exemplary embodiment, a prohibited address string 407 is divided into two-character pairs, or bigrams. Specifically, the address string “123 Main St” is broken up into ten two-character pairs, as illustrated in exemplary table 401 representing all of the adjacent two character/whitespace combinations in the original address. This produces a variable 409 having a value of “10,” which corresponds to the variable A in equation (1) above, used for calculating a dice coefficient. Similarly, the address string 411 entered by the person attempting to purchase a firearm is also broken up into two-character pairs, as illustrated in exemplary table 403. In this particular embodiment, the address string 411 is “123 Naim St.” Variable 413 includes ten two-character pairs, and therefore has a value of “10,” which corresponds to variable, B in equation (1) above, used for calculating a dice coefficient. Once the entered address 411 and prohibited address string 407 have been broken up into two-character pairs, each pair from address string 411 is compared against its corresponding pair in address string 407 in order to determine which pairs intersect or overlap. The overlapping pairs corresponding to this exemplary embodiment are shown in table 405. In this particular example, there are six overlapping pairs, which results in a variable 415 having a value of “6,” which corresponds to variable C in equation (1) above. Once the variables A, B, and C (409, 413, and 417) have been calculated, they may be inserted into equation (1) above to compute the dice coefficient corresponding to the normalized address string “123 Naim St.” In this particular embodiment, entering variables 409 413, and 417 into equation (1) results n a dice coefficient of 60.

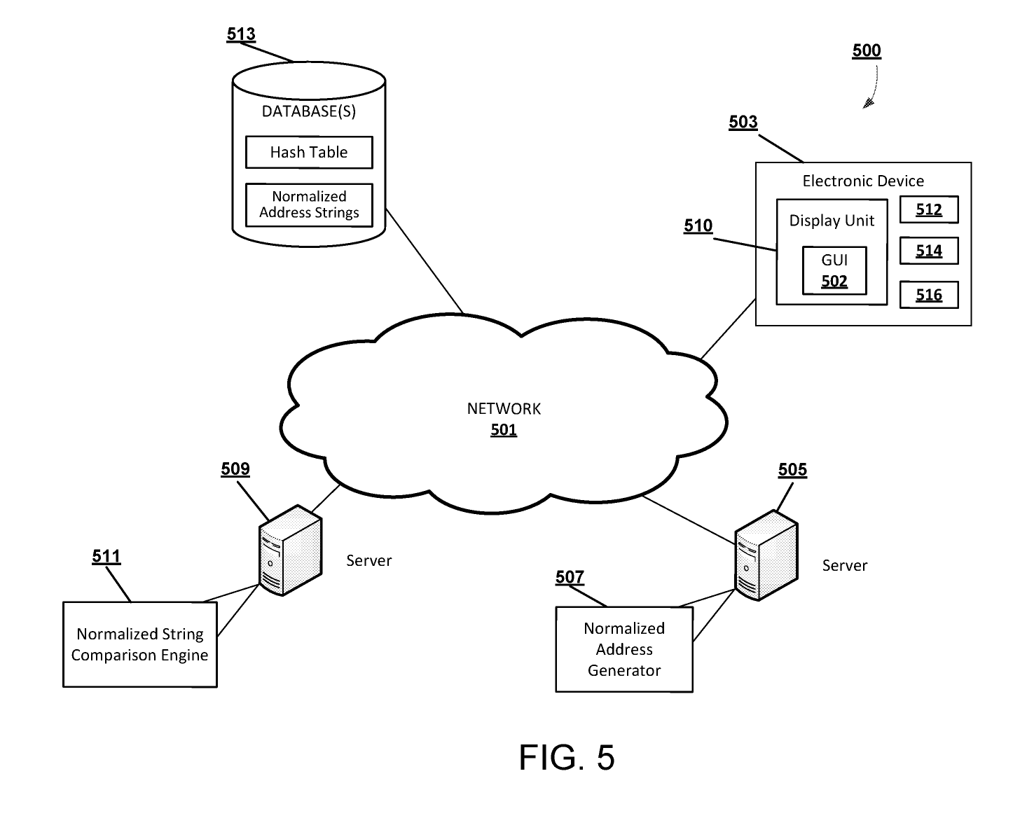

FIG. 5 is a diagram of an example network environment 500 suitable for a distributed implementation of example embodiments. The network environment 500 can include one or more servers 505 and 509, and a database 513, associated with servers 505 and 509. In exemplary embodiments, the database 513 can store the various normalized address strings and/or hash tables, while the servers 505 and 509 can store normalized address generator 507 and normalized string comparison engine 511, which can implement one or more of the processes described herein with respect to FIGS. 1-3. The network environment may also include an electronic display device 503, that may display a GUI 502 to a user. The electronic display device 503 can include a display unit 510; a processing device 512; memory 514; and a network interface 516 where the processing device executes instructions in memory (e.g., in response to instructions from the server 505 or 509) to control an operation of the display unit as described herein. Once the electronic device 503 receives instructions transmitted by the servers 505 or 509 (e.g., via the network interface 516), the GUI 502 may be rendered on the display unit 510 of the electronic device 503 (e.g., in response to execution of the instructions by the processing device 512) to allow a user of the electronic device 503 to interact with the server 505 or 509 to implement embodiments of the present invention.

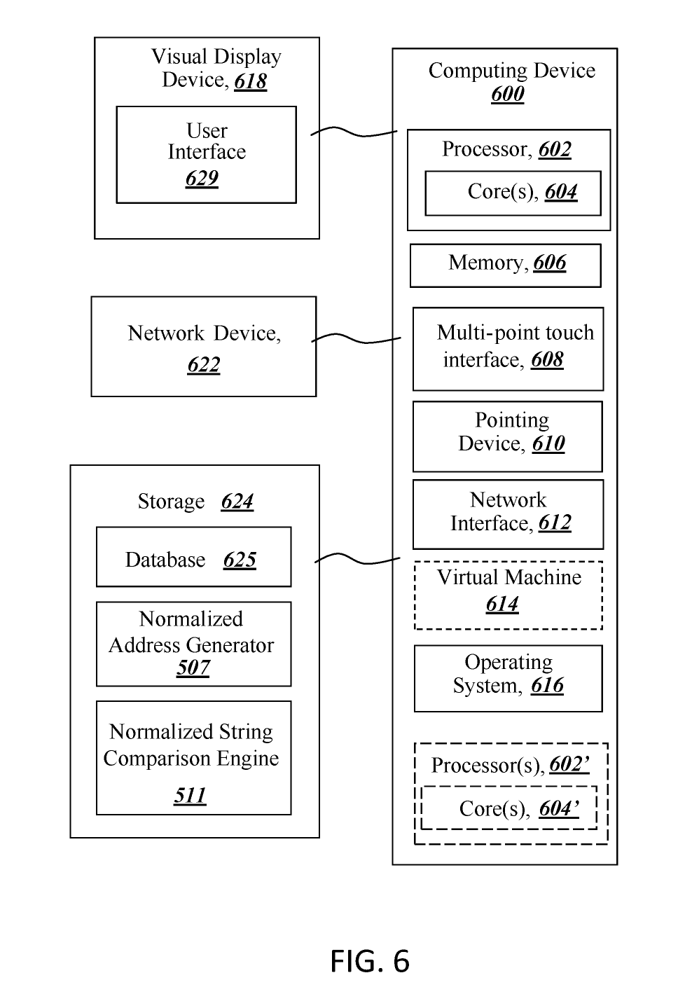

In exemplary embodiments, the servers 505 and 509, database 513, and the electronic device 503 may be in communication with each other via a communication network 501. The communication network 501 may include, but is not limited to, the Internet, an intranet, a LAN (Local Area Network), a WAN (Wide Area Network), a MAN (Metropolitan Area Network), a wireless network, an optical network, and the like. In exemplary embodiments, the electronic device 503 that is in communication with the servers 505 and 509, and database 513 can generate and transmit a database query requesting information from the raw data matrices or database 513. As described above in reference to FIGS. 1-3, the servers 505 and 509 can transmit instructions to the electronic device 503 over the communication network 501. The servers 505 and 509 can interact with the electronic device 503 and database 513 over communication network 501 to render a GUI on an operation of the electronic device 503, as described herein. Each of the servers 505 and 509, normalized address generator 507, normalized string comparison engine 511, and electronic device 503, can be implemented using one or more components described in reference to computing device 600 and visual display device 618, which are discussed in more detail below with respect to FIG. 6.

FIG. 6 is a block diagram of an exemplary computing device 600 that can be used in the performance of any of the example methods according to the principles described herein. The computing device 600 includes one or more non-transitory computer-readable media for storing one or more computer-executable instructions (such as but not limited to software or firmware) for implementing any example method according to the principles described herein. The non-transitory computer-readable media can include, but are not limited to, one or more types of hardware memory, non-transitory tangible media (for example, one or more magnetic storage disks, one or more optical disks, one or more USB flashdrives), and the like. For example, memory 606 included in the computing device 600 can store computer-readable and computer-executable instructions or software for implementing exemplary embodiments, such as address normalization generator 507 or normalized string comparison engine 511, programmed to perform processes described herein. The computing device 600 also includes processor 602 and associated core 604, and optionally, one or more additional processor(s) 602′ and associated core(s) 604′ (for example, in the case of computer systems having multiple processors/cores), for executing computer-readable and computer-executable instructions or software stored in the memory 606 and other programs for controlling system hardware. Processor 602 and processor(s) 602′ can each be a single core processor or multiple core (604 and 604′) processor.

Virtualization can be employed in the computing device 600 so that infrastructure and resources in the computing device can be shared dynamically. A virtual machine 614 can be provided to handle a process running on multiple processors so that the process appears to be using only one computing resource rather than multiple computing resources. Multiple virtual machines can also be used with one processor.

Memory 606 can be non-transitory computer-readable media including a computer system memory or random access memory, such as DRAM, SRAM, EDO RAM, and the like. Memory 606 can include other types of memory as well, or combinations thereof.

A user can interact with the computing device 600 through a visual display device 618, such as a touch screen display or computer monitor, which can display one or more user interfaces 629 that can be provided in accordance with exemplary embodiments. The computing device 600 can include other I/O devices for receiving input from a user, for example, a keyboard or any suitable multi-point touch interface 608, a pointing device 610 (e.g., a pen, stylus, mouse, or trackpad). The keyboard 608 and the pointing device 610 can be coupled to the visual display device 618. The computing device 600 can include other suitable conventional I/O peripherals.

The computing device 600 can also include one or more storage devices 624, such as a hard-drive, CD-ROM, or other non-transitory computer readable media, for storing data and computer-readable instructions and/or software, such as the normalized address generator 507, and the normalized string comparison engine 511, which may implement exemplary embodiments of the methods and systems as taught herein, or portions thereof. Exemplary storage device 624 can also store one or more databases 625 for storing any suitable information required to implement exemplary embodiments. The databases can be updated by a user or automatically at any suitable time to add, delete or update one or more items in the databases. Exemplary storage device 624 can store one or more databases 625 for storing normalized address strings, hash tables, and any other data/information used to implement exemplary embodiments of the systems and methods described herein.

The computing device 600 can include a network interface 612 configured to interface via one or more network devices 622 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. The network interface 612 can include a built-in network adapter, network interface card, PCMCIA network card, card bus network adapter, wireless network adapter, USB network adapter, modem or any other device suitable for interfacing the computing device 600 to any type of network capable of communication and performing the operations described herein. Moreover, the computing device 600 can be any computer system, such as a workstation, desktop computer, server, laptop, handheld computer, tablet computer (e.g., the iPad® tablet computer), mobile computing or communication device (e.g., the iPhone® communication device), or other form of computing or telecommunications device that is capable of communication and that has sufficient processor power and memory capacity to perform the operations described herein.

The computing device 600 can run any operating system 616, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, any operating systems for mobile computing devices, or any other operating system capable of running on the computing device and performing the operations described herein. In exemplary embodiments, the operating system 616 can be run in native mode or emulated mode. In an exemplary embodiment, the operating system 616 can be run on one or more cloud machine instances.

In describing example embodiments, specific terminology is used for the sake of clarity.

For purposes of description, each specific term is intended to at least include all technical and functional equivalents that operate in a similar manner to accomplish a similar purpose. Additionally, in some instances where a particular example embodiment includes a plurality of system elements, device components or method steps, those elements, components or steps can be replaced with a single element, component or step. Likewise, a single element, component or step can be replaced with a plurality of elements, components or steps that serve the same purpose. Moreover, while example embodiments have been shown and described with references to particular embodiments thereof, those of ordinary skill in the art will understand that various substitutions and alterations in form and detail can be made therein without departing from the scope of the invention. Further still, other aspects, functions and advantages are also within the scope of the invention.

Example flowcharts are provided herein for illustrative purposes and are non-limiting examples of methods. One of ordinary skill in the art will recognize that example methods can include more or fewer steps than those illustrated in the example flowcharts, and that the steps in the example flowcharts can be performed in a different order than the order shown in the illustrative flowcharts.

What is claimed is:

1. A system for providing approval or denial of an attempted firearm purchase, the system comprising:
one or more servers programmed to:
receive, in an electronic computer-readable format at a normalized address generator, address information of a person attempting to purchase a firearm, the address information including address elements;
transform at least one of the address elements to a normalized address element;
generate a normalized address string including the normalized address element;
generate, via a normalized string comparison engine, a similarity coefficient by comparing the normalized address string to a prohibited normalized address string corresponding to a prohibited address associated with a person prohibited from purchasing firearms; and
compare the similarity coefficient to a first threshold value; and
an electronic display device programed to:
provide approval or denial of the attempted firearm purchase based at least in part on a comparison of the similarity coefficient to the first threshold value.

2. The system of claim 1, wherein the one or more servers are further programmed to provide approval or denial of an attempted firearm purchase based on time elapsed since a previous firearm purchase attempt from a customer at the prohibited address, in response to the similarity coefficient being higher than the first threshold value.

3. The system of claim 1, wherein the similarity coefficient is a dice coefficient computed based on pairs of characters from the normalized address string and a prohibited normalized address string.

4. The system of claim 1, wherein transforming at least one of the address elements to a normalized address element includes comparing the at least one address element to a hash table of commonly used address inputs and address abbreviations.

5. The system of claim 1, the one or more servers are further programmed to compare the similarity coefficient to a second threshold value; and wherein the electronic display device is further programmed to:
provide approval of an attempted firearm purchase if the similarity coefficient is below the first threshold value;
prompt a sales associate to request additional information from the person attempting to purchase the firearm if the similarity coefficient is above the first threshold value and below the second threshold value; and
automatically deny the attempted firearm purchase if the similarity coefficient is above the second threshold value.

6. The system of claim 5, wherein the additional information includes resident history or identification information.

7. The system of claim 5, the electronic display device further programmed to provide approval or denial of an attempted firearm purchase based on the additional information provided by the person attempting to purchase the firearm.

8. A method of providing approval or denial of an attempted firearm purchase, the method comprising:
receiving, in an electronic computer-readable format at a normalized address generator, address information of a person attempting to purchase a firearm, the address information including address elements;
transforming, using the normalized address generator, at least one of the address elements to a normalized address element;
generating, using the normalized address generator, a normalized address string including the normalized address element;
generating, using a normalized string comparison engine, a similarity coefficient by comparing the normalized address string to a prohibited normalized address string corresponding to a prohibited address associated with a person prohibited from purchasing firearms;
comparing the similarity coefficient to a first threshold value; and
providing approval or denial of the attempted firearm purchase based at least in part on a comparison of the similarity coefficient to the first threshold value.

9. The method of claim 8, further comprising, in response to the similarity coefficient being higher than the first threshold value, providing approval or denial of an attempted firearm purchase based on time elapsed since a previous firearm purchase attempt from a customer at the prohibited address.

10. The method of claim 8, wherein the similarity coefficient is a dice coefficient computed based on pairs of characters from the normalized address string and a prohibited normalized address string.

11. The method of claim 8, wherein transforming at least one of the address elements to a normalized address element includes comparing the at least one address element to a hash table of commonly used address inputs and address abbreviations.

12. The method of claim 8, further comprising:
comparing the similarity coefficient to a second threshold value;
providing approval of an attempted firearm purchase if the similarity coefficient is below the first threshold value;
prompting a sales associate to request additional information from the person attempting to purchase the firearm if the similarity coefficient is above the first threshold value and below the second threshold value; and
automatically denying the attempted firearm purchase if the similarity coefficient is above the second threshold value.

13. The method of claim 12, wherein the additional information includes resident history or identification information.

14. The method of claim 12, further comprising providing approval or denial of an attempted firearm purchase based on the additional information provided by the person attempting to purchase the firearm.

15. A non-transitory computer readable medium storing instructions executable by a processing device, wherein execution of the instructions causes the processing device to implement a method of providing approval or denial of an attempted firearm purchase, the method comprising:
receiving, in an electronic computer-readable format at a normalized address generator, address information of a person attempting to purchase a firearm, the address information including address elements;
transforming, using the normalized address generator, at least one of the address elements to a normalized address element;
generating, using the normalized address generator, a normalized address string including the normalized address element;
generating, using a normalized string comparison engine, a similarity coefficient by comparing the normalized address string to a prohibited normalized address string corresponding to a prohibited address associated with a person prohibited from purchasing firearms;
comparing the similarity coefficient to a first threshold value; and
providing approval or denial of the attempted firearm purchase based at least in part on a comparison of the similarity coefficient to the first threshold value.

16. The medium of claim 15, wherein execution of the instructions further causes the processing device to provide approval or denial of an attempted firearm purchase based on time elapsed since a previous firearm purchase attempt from a customer at the prohibited address, in response to the similarity coefficient being higher than the first threshold value.

17. The medium of claim 15, wherein the similarity coefficient is a dice coefficient computed based on pairs of characters from the normalized address string and a prohibited normalized address string.

18. The medium of claim 15, wherein transforming at least one of the address elements to a normalized address element includes comparing the at least one address element to a hash table of commonly used address inputs and address abbreviations.

19. The medium of claim 15, wherein execution of the instructions further causes the processing device to:
compare the similarity coefficient to a second threshold value;
provide approval of an attempted firearm purchase if the similarity coefficient is below the first threshold value;
prompt a sales associate to request additional information from the person attempting to purchase the firearm if the similarity coefficient is above the first threshold value and below the second threshold value; and
automatically deny the attempted firearm purchase if the similarity coefficient is above the second threshold value.

20. The medium of claim 19, wherein execution of the instructions further causes the processing device to provide approval or denial of an attempted firearm purchase based on the additional information provided by the person attempting to purchase the firearm.
